(19) United States
(12) Patent Application Publication
(10) Pub. No.: US 2014/0278454 A1
(43) Pub. Date: Sep. 18, 2014

(54) DYNAMIC PRICING OF HEALTHCARE RESOURCES

(71) Applicant: FTV SOLUTIONS, INC., Los Angeles, CA (US)

(72) Inventor: Yael Peled, Los Angeles, CA (US)

(73) Assignee: FTV Solutions, Inc., Los Angeles, CA (US)

(21) Appl. No.: 13/800,704

(22) Filed: Mar. 13, 2013

(51) Int. Cl. G06Q 30/02; G06Q 50/22

(52) U.S. Cl. CPC G06Q 30/0206; G06Q 50/22
USPC 705/2

(57) ABSTRACT

A dynamic pricing system for scheduling healthcare resources to deliver healthcare services during optimal time periods is disclosed. In some embodiments, a system and method for scheduling appointment slots for use in allocating utilization of a healthcare resource based on dynamic pricing constraints is disclosed. In some embodiments, a system and method for computing prices corresponding to appointment slots associated with a healthcare resource using dynamic pricing constraints is disclosed. The dynamic pricing constraints are derived from resource data including real-time data, historical data, and provider data. The dynamically computed price for each appointment slot associated with the healthcare resource reflects the flow in supply and demand associated with the resource.

### FIELD OF INVENTION

The present invention relates generally to pricing resources, and more particularly to pricing healthcare resources using a dynamic pricing system.

### BACKGROUND

The healthcare industry is a business system that can benefit greatly from robust, efficient operations. One important consideration for any robust system is the consumption, utilization, and allocation of the resources exchanged between the parties within the system. The current healthcare infrastructure operates on a need-based basis when it comes to healthcare resources, without regard for important aspects such as supply or demand. As a result, consumers (e.g., patients, insurance companies, etc.) face exorbitantly high costs and providers (e.g., hospitals, clinics, etc.) lose profits as the resources are inadequately utilized. Minimizing and curtailing high costs and expenses associated with the resources are essential to enable a robust healthcare industry. However, it is often difficult to accurately identify and manage the consumption, utilization, and allocation of the resources without an efficient system in place.

### BRIEF DESCRIPTION OF THE DRAWINGS

One or more embodiments of the present invention are illustrated by way of example and not limitation in the figures of the accompanying drawings.

FIG. 1 is a network diagram of an environment 100 in which a dynamic pricing system operates.

FIG. 2 is a high-level block diagram illustrating an example of the architecture of a dynamic pricing server system in accordance with one or more embodiments of the present invention.

FIG. 3 is a flow diagram illustrating an example process for scheduling utilization of a resource in accordance with one or more embodiments of the present invention.

FIG. 4 is a flow diagram illustrating an example process for determining a plurality of appointments according to one or more embodiments of the present invention.

FIG. 5 is a flow diagram illustrating an example process for computing a price associated with an appointment slot in accordance with one or more embodiments of the present invention.

FIG. 6 is a block diagram illustrating an architecture of the pricing module in accordance with one or more embodiments of the present invention.

FIG. 7 is an example illustrating a user interface 700 on which a client may connect to the pricing server in accordance with one or more embodiments of the present invention.

### DETAILED DESCRIPTION

Various embodiments of the present invention relate to a dynamic pricing system that optimizes utilization of a healthcare resource by scheduling service of the resource using a dynamic pricing algorithm. As healthcare services often require utilization of expensive resources, demand for service at a specific time plays an important role in reducing costs for all parties involved. However, no system exists to enable scheduling of the healthcare resources (and the accompanying healthcare services) in an optimal, cost-saving way.

Under the current healthcare infrastructure, a resource for healthcare service is typically requested from a provider based on immediate needs, and the provider provides the resource at the same standard price, at all times. There is no consideration of the flow in supply and demand in the transaction. For example, a consumer (e.g., patient, insurance company, etc.) requests an MRI machine whenever a need for an MRI screening arises. The provider typically offers the MRI machine at the standard industry price, regardless of the demand or supply at the moment, and the consumer has to accept even the most exorbitant price. In some instances, however, the MRI machines may be sitting idle, yet no MRI screenings are requested. The consumers may not know about the availability and/or the providers may not have a way to advertise such availability. In such instances, the providers have already paid for the technician, the secretary, the air conditioning, etc. associated with the machine. These providers may want to offer the machines for service at a discount to recover some of the expenditures. However, as the availability is not known by the consumers, no recovery is possible. In other instances, the MRI machines may be in high demand (and possibly low supply) at certain time periods. In these instances, the providers may benefit by charging a higher price for resource utilization during those periods. However, as the convention is to charge the standard price, without looking into additional factors, no additional profit can be made. As a result, the consumers continue facing exorbitantly high costs while the providers' resources remain inadequately utilized.

In contrast, various embodiments of the present invention optimize the utilization of healthcare resources by using a dynamic pricing system. The dynamic pricing system facilitates scheduling of the healthcare resources for service during optimal time periods based on various dynamic pricing constraints. The dynamic pricing constraints are derived from data inputs related to the flow of supply and demand of each healthcare resource being offered for service. As will be discussed further in detail below, the data inputs include historical and real-time data provided by the resource provider (e.g., current available appointments, deep discount for forecast slow months, etc.), historical data associated with the resource (e.g., demand based on past trends), and real-time data associated with the resource (e.g., current supply of the resource). Using the data inputs, the dynamic pricing system dynamically computes a price for each appointment slot that is available for resource utilization, where the price reflects an optimal time for both the provider and the consumer. As will be discussed further in detail below, the optimal time occurs during time periods at which a resource may be utilized for the best value, for the consumer and the provider alike. For example, the off-hours on a Sunday, which are outside of normal working hours (e.g., Mon-Fri from 9 am-5 pm), are optimal hours (i.e., optimal time) for a hospital to offer service of its MRI machine (at a discount). The hospital is able to make more profit by putting to use an idle MRI machine, and the consumer is able to benefit from a cheaper price by opting to use the machine on a weekend time slot.

Certain implementations of the various embodiments of the present invention provide many benefits, including, but are not limited to: (1) maximizing profit for resource providers through optimal utilization of their resources; (2) reducing coverage costs for insurance companies through availability of optimal choices for healthcare services; and (3) reducing overall costs and enhancing overall experience for patients through transparency and freedom of choice for healthcare services.

The various embodiments of the present invention disclosed optimally work for a healthcare resource that has a high fixed cost, a low variable cost, and a low dependency on the provider(s). For example, an MRI machine is an optimally fitted resource for the disclosed present invention. In particular, the typical MRI machine has a (high) fixed cost of $1-2M, where providers generally charge a “rental” price of $1000 per hour in order to compensate for the high fixed cost. However, the actual operation cost for the MRI machine is very low, such that reducing the “rental” price to a low variable cost, such as $100 per hour, is possible without undercutting any profit for the providers. Under the present invention, the providers have an attractive alternative to compensate (i.e., make more profit) for the machine's cost, and the consumers are saved from the standard high price. Additionally, there is low dependency on the provider when it comes to utilization of the MRI machine; there is no need for the MRI machine during the off-hours (e.g., before 7 am and/or after 6 pm when normal business hours are from 7 am-6 pm). It is noted, however, while, for convenience, embodiments of the present invention are described with reference to healthcare resources, embodiments of the present invention may be extended to other non-healthcare environments (e.g., industrial, commercial, etc.) where dynamic pricing of resources to optimize utilization among participating parties is prevalent.

Various aspects and examples of the invention will now be described with reference made to the accompanying drawings. Wherever practicable, the same reference numbers will be used throughout the drawings to refer to the same or like parts. Note that the following description provides specific details for a thorough understanding and enabling description of these examples. One skilled in the art will understand, however, that the invention may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

The phrases “in some embodiments,” “according to various embodiments,” in the embodiments shown,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or to different embodiments.

The words “herein,” “above,” “below,” and words of similar import, when used in this application, refer to this application as a whole and not to any particular portions of this application. The words “comprise,” “comprising,” and the like are to be construed in an inclusive sense (i.e., to say, in the sense of “including, but not limited to”), as opposed to an exclusive or exhaustive sense. Additionally, the terms “connected,” “coupled,” or any variant thereof means any connection or coupling, either direct or indirect, between two or more elements. Such a coupling or connection between the elements can be physical, logical, or a combination thereof.

Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list. Further, if the Detailed Description states a component or feature “may,” “can,” “could,” or “might” have a characteristic or be included, that particular component or feature is not required to have that characteristic or be included.

FIG. 1 is a network diagram of an environment 100 in which a dynamic pricing system operates. However, various modifications to the environment 100, such as an inclusion of additional devices and/or modules, consolidation and/or deletion of various devices and/or modules, and the shifting of functionality from one device and/or module to another, may be made without deviating from the present invention. Referring to FIG. 1, the environment 100 includes a dynamic pricing server computer system 110 (hereinafter, “pricing server”).

The pricing server 110 is in communication with a provider 120 and a client 130 via a network 102. Through the pricing server 110 via the network 102, the client 130 may submit to the provider 120 an appointment request to search for time periods at which a healthcare resource is available for healthcare service. The provider 120, through the pricing server 110, returns to the client 130 one or more available appointments from which the client 130 may schedule to utilize the healthcare resource. As will be discussed in further detail below, each appointment comprises an appointment time slot offered at a corresponding price, where the corresponding price is computed and dynamically adjusted based on various data inputs associated with the resource (hereinafter, “resource data”). Scheduling of a given appointment slot at the corresponding price enables utilization of the healthcare resource at an optimal time, for both the provider and the consumer.

The term “healthcare resource” as used herein may be a plurality of resources used to deliver healthcare services. In one example, the healthcare resource is a healthcare service delivered by a caretaker (e.g., a doctor, a nurse, a technician operating a homeowner's medical device, etc.), where scheduling for the resource involves obtaining the caretaker's service for a block of time. In another example, the healthcare resource is a hospital bed, an MRI machine, an X-Ray machine, an EKG machine, and the like. In some instances, the same resource may be offered by more than one provider via the pricing server 110. Hospital X, hospital Y, and hospital Z each has an MRI machine available, for example, for use at various time slots on Sunday. In this example, an individual set of appointments associated with the MRI machine is offered by the pricing server 110 on behalf of each provider 120 to the client 130. For example, the following appointments are presented in response to an appointment request from the client 130:

| | | |
|---|---|---|
| Hospital X | 8-9 am | $400 |
| Hospital Y | 8-9 am | $350 |
| Hospital X | 1-2 pm | $500 |
| Hospital X | 8-9 pm | $300 |
| Hospital Z | 9-10 pm | $350 |
| Hospital Z | 10-11 pm | $100 |

In other instances, the same provider 120 may offer more than one resource via the pricing server 110. For example, hospital X has available two resources, an MRI machine and an X-Ray machine, for service in the next five days. In this example, hospital X may offer appointments associated with both resources through the pricing server 110, where only the appointments associated with a particular appointment request are generated for the client 130 (e.g., only appointments for the X-Ray machine are generated in response to an X-ray appointment request).

The pricing server 110 may be any computing device capable of communication with the network 102 to connect with the provider 120 and to provide content to users of the client 130 (e.g., a laptop, a mobile device, etc.). Devices that may operate as the pricing server 140 include, but are not limited to, general-purpose computers, multi-processor systems, microprocessor-based or programmable consumer electronic devices, servers, and/or the like. The pricing server 110 may be a single computing device. Additionally, functionality of the pricing server 110 may be distributed across multiple computing devices or may be integrated into another device, such as an SMS gateway and/or the like.

The client 130 may be any computing device configured to execute applications, such as a desktop, a laptop, a mobile device, or the like. The client 130 may be used by a user, such as a consumer, to access the pricing server 110. For example, a consumer connects to the pricing server by using a browser on a laptop to search for an MRI machine. A “consumer” as defined herein is an entity that consumes, or uses, the resource being requested. In one example, the consumer is a patient, who has been authorized by his/her physician to have an MRI screening. The patient personally accesses the pricing server 110 to request an appointment for utilizing an MRI machine, where the appointment is optimal for the patient's time and financial situation. In another example, the consumer is an insurance's third party agent assisting the insurance company in identifying a cost-optimal healthcare service option for an insurance client. In yet another example, the consumer is a hospital that experiences a resource shortage and needs additional units temporarily to deliver the necessary healthcare services. In embodiments, the client 130 may be a plurality of clients accessing the pricing server 110 to fulfill a variety of needs (i.e., making appointment requests for a variety of healthcare resources).

The provider 120 may be a plurality of providers connected to the pricing server 110. Using the pricing server 110, the provider is able to offer its healthcare resources “for sale” by offering services of the resources in the form of appointments. The appointments may be designated in time intervals specified by the provider (e.g., 30-min appointments, 1-hr appointments, 2-day appointments, etc.). As discussed herein, a “provider” is any “seller” who offers one or more healthcare resources for healthcare services to the consumers at certain available time slots. In one example, the provider 120 is a healthcare facility (e.g., a hospital, a medical clinic, etc.). The provider 120 of one particular healthcare resource may become a consumer of another healthcare resource. For example, hospital X, which is an X-Ray imaging facility that maintains a large inventory of X-Ray machines, may be a consumer of MRI machines.

In embodiments, the pricing server enables any healthcare facility to increase the utilization of its healthcare resources by offering services of those resources at dynamic prices. As will be discussed in further detail below, the prices are dynamically computed based on various data inputs related to the flow in supply and demand of the resources (hereinafter, “resource data”). The resource data include, for example, parameter values set by the providers, input values provided by the providers, historical data and real-time data associated with the healthcare resource. By dynamically adjusting the price of a particular resource depending on the resource data, the provider's profit is maximized while the patient costs and the insurance costs are reduced.

FIG. 2 is a high-level block diagram illustrating an example of the architecture of a dynamic pricing server computer system 200 (hereinafter, “the pricing server”). The pricing server 200 may represent the dynamic pricing server computer system 110 of FIG. 1. The pricing server 200 includes one or more processors 202 and a memory 204 coupled to an interconnect 210. The interconnect 210 shown in FIG. 2 is an abstraction that represents any one or more separate physical buses, point-to-point connections, or both connected by appropriate bridges, adapters, or controllers. The interconnect 210, therefore, may include, for example, a system bus, a Peripheral Component Interconnect (PCI) family bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, sometimes referred to as “Firewire.”

The processor(s) 202 may include central processing units (CPUs) of the server 200 and, thus, control the overall operation of the server 200. The processor(s) 202 is in communication with the memory 204. In some embodiments, the processor(s) accomplish this by executing software or firmware stored in the memory 204. The processor(s) 202 may include one or more programmable general-purpose or special-purpose microprocessors, digital signal processors (DSPs), programmable controllers, application specific integrated circuits (ASICs), programmable logic devices (PLDs), or the like, or a combination of such devices.

The memory 204 includes the main memory of the pricing server 200. The memory 204 includes a pricing module 206 and a scheduling module 208. The memory 204 represents any form of random access memory (RAM), read only memory (ROM), flash memory, or the like, or a combination of such devices. The memory 204 is operable to store computer readable program instructions for execution by the processor(s) 202. An embodiment of the computer readable program instructions may be arranged in the pricing module 206. Another embodiment of the computer readable program instructions may be arranged in the scheduling module 208. In embodiments, the pricing module 206 is configured to compute dynamically prices based on resource data to satisfy a client's appointment request for utilizing a healthcare resource. In embodiments, the scheduling module 208, coupled to the pricing module 206, is configured to determine a plurality of appointment slots available from a provider in response to the appointment request, link the prices computed by the pricing module 206 to the plurality of appointment slots, display the plurality of appointments, comprising the slots and the prices, to the client, and schedules utilization of the healthcare resource in a given appointment on behalf of the client. The pricing module 206 and the scheduling module 208 are preferably executed by the processor(s) 202.

A local storage 220, a storage adapter 230, and a network adapter 240 are also connected to the processor(s) 202 through the interconnect 210. The local storage 220 may be a local database. The local database may store, for example, historical data associated with the healthcare resource. In another example, the local database may store dynamically computed prices associated with the healthcare resource. The storage adapter 230 allows the pricing server 200 to access data (e.g., historical data) stored on one or more remote databases of a storage subsystem 232. Through the storage adapter 230, the local storage 220 may be in communication with the one or more remote databases of the storage subsystem 232. The network adapter 240 provides the pricing server 200 with the ability to communicate with remote devices, such as clients, over a network 242. The network adapter may be, for example, an Ethernet adapter.

FIG. 3 is a flow diagram illustrating an example process 300 generally representative of multiple program instructions of the scheduling module 208, coupled to the pricing module 206, for execution by the processor(s) 202 of the pricing server 200 in FIG. 2. Referring to FIG. 3, at step 302, the pricing server receives an appointment request from a user using the client 130 via the network 102 of FIG. 1. In some embodiments, the appointment request takes the form of a search query in which the user submits search criteria to request for available time periods at which a particular healthcare resource is available for use (e.g., time slots at which an MRI machine are available to rent for an MRI screening). The search criteria may include, for example, a resource type, an appointment date, a preferred time period, a price range, and the like. In some instances, the user may specify, in the search criteria, details related to the user's personal insurance coverage. In such instances, the pricing server is able to return to the user a personalized set of appointments, where the prices computed for the appointment slots take into consideration the insurance coverage.

At step 304, the pricing server determines a plurality of appointments available from a provider for utilization of the healthcare resource. In embodiments, each of the plurality of appointments includes an appointment slot (i.e., a time slot) and a price corresponding to that slot. In particular, before computing a corresponding price, the pricing server first determines a plurality of appointment slots available from the provider. In some instances, there may only be one appointment slot available, with only one provider having the requested resource. In other instances, there may be several appointment slots available from the provider (or a plurality of providers). In such instances, the appointment slots are a mix of time slots from the plurality of providers.

In embodiments, to determine the plurality of appointment slots available, the pricing server looks to data inputs provided by the provider specifying certain constraints associated with scheduling of the healthcare resource for service. In particular, determining the plurality of appointment slots requires looking into provider input values that specify the number of available appointments available from a provider for providing service of a particular resource (hereinafter, “appointment availability information”). In some instances, the appointment availability information is submitted by the provider ahead of time at certain time intervals (e.g., every hour, every day, every week, etc.). The submission may include, for example, the availability of all healthcare resources available for service from the provider (e.g., five calendars associated with five resources that are available for service). The submission may be done, for example, via a website portal through the network 102. The appointment availability information is then stored, for example, in a database of the pricing server, where the availability information is periodically updated with each new submission by the provider. In these instances, the pricing server accesses the stored availability information whenever there is an appointment request. In other instances, the appointment availability information is dynamically retrieved from a provider in real-time, in response to the appointment request. The process of dynamically retrieving the availability may be implemented, for example, using an Application Programming Interface (API). In yet other instances, the provider maintains its own appointment availability information (e.g., on a provider scheduling system), and connects to the pricing server to request for dynamically computed prices to satisfy requests submitted on the provider scheduling system.

Subsequent to a determination of available appointment slots, the pricing server proceeds to compute the price for each appointment slot, as will be discussed in further detail in process 400 of FIG. 4. At step 306, the pricing server returns to the user the plurality of appointments containing the appointment slots and the corresponding prices. In some instances, the plurality of appointments is generated as one set of appointments from the same provider. In other instances, two or more sets of appointments are generated. As discussed above, the multiple sets of appointments are indicative of the fact that multiple providers have the requested resource available for service. In such instances, each set of appointments is particular to each provider, and as such, each set contains different appointment slots fixed at different prices than those offered by other providers. For example, a set of appointments for an appointment request of a resource R may include (i) appointment slots A, B, and C offered at price p1, p2, and p3 from provider X and (ii) appointment slots D, E, and F offered at price P1, P2, and P3 from provider Y. In some embodiments, a display of the sets of appointments may be organized by provider, where the separation between providers is clear. In some embodiments, the display of the sets of appointments may be organized by appointment time, where the provider is specified only for each appointment slot. In some embodiments, the display of the sets of appointments may be organized by price. Various other organizations may be utilized in other embodiments.

At step 308, the user's selection of a given appointment from the plurality of appointments is received. At step 310, the pricing server determines whether a final submission has occurred. A final submission has occurred, for example, when the user selects a given appointment and completes payment for the service associated with that appointment slot. If no final submission has occurred, (e.g. a user resubmits a new search query), steps 302-308 are repeated. In embodiments, the user may change the selection however many times desired, in addition to changing the search query. If a final submission has occurred, the pricing server schedules the resource for the given appointment selected, as indicated in step 312. The process 300 ends at step 314, where a return to step 302 may be repeated for every new appointment request.

In some embodiments, the pricing server updates the supply value associated with the resource in response to the scheduling of the resource. In some embodiments, the pricing server transmits, in response to the scheduling, a notification to the provider associated with the given appointment time slot selected.

FIG. 4 is a flow diagram illustrating an example process 400 for determining a plurality of appointments according to one or more embodiments of the present invention. The process 400 is generally representative of multiple program instructions of the pricing module 206, coupled to the scheduling module 208, for execution by the processor(s) 202 of the pricing server 200 in FIG. 2. The process 400 may be executed, for example, during step 304 of the process 300 (FIG. 3). At step 402, the pricing server, via the pricing module coupled to the scheduling module, retrieves data inputs associated with the particular resource being requested (hereinafter, “resource data”). The resource data places certain constraints on computing the prices for the available appointment time slots, such that the prices are dynamically reflective of the flow in supply and demand associated with the resources. As will be discussed in further detail below, the resource data include historical data, real-time data, and provider data. It is noted that the provider data includes the appointment availability information. At step 404, a plurality of appointment slots are determined using the appointment availability information.

At step 406, the pricing module takes into consideration the appointment availability information, in addition to the real-time data, the historical data, and additional provider data, to proceed in computing a price for each of the appointment time slot. For example, if five appointment slots associated with the requested resource are determined as available, a total of five prices are computed corresponding to those slots. Each corresponding price is different depending on the historical data, the real-time data, and the additional provider data.

At step 408, the plurality of appointments, comprising the appointment slots and the prices are generated. In some embodiments, the plurality of appointments include a plurality of insurance prices and a plurality of co-pay amounts corresponding to the insurance prices, in addition to the plurality of appointment slots and prices. The plurality of insurance prices and corresponding co-pay amounts are derived from the plurality of prices dynamically computed for the plurality of appointment slots. In some instances, the plurality of insurance prices (and the co-pay amounts) are determined based on standard insurance coverage rates. In other instances, the plurality of insurance prices (and the co-pay amounts) are determined based on insurance coverage rates provided in the appointment request, where the insurance prices (and co-pay amounts) are personalized to the particular user submitting the request. The process 400 ends at step 410, where a return to step 402 may be carried out whenever a plurality of appointments are determined.

In some embodiments, the plurality of appointments generated at step 408 are stored in memory, such as a local database of the local storage 220 and/or a remote database of the storage subsystem 232 (FIG. 2). In embodiments, the process 400 is executed, for example, on a periodical basis, for a plurality of healthcare resources, where the prices for the appointment slots associated with each resource are dynamically adjusted at a certain time interval (e.g., every 30 minutes) based on the resource data (e.g., a change in supply). The prices, for the plurality of resources, are updated in the database accordingly to the dynamic adjustments. The time interval for updating the stored prices may be a configurable parameter of the system.

The stored prices are then retrieved from the database for display in response to any appointment request associated with a particular resource. In some instances, a criterion parameter may be set to determine whether the stored prices should be recomputed before the display. For example, the criterion may be time-based, where if less than 1 minute has passed, the prices are not recomputed. In another example, the criterion may be resource data based, where if a change in a particular resource data value is detected, the prices are recomputed. In other instances, no criterion parameter is set, and the prices are retrieved from the database for immediate display to the user.

In some embodiments, the plurality of appointments generated at step 408 are displayed immediately to the user, bypassing system storage. In embodiments, the process 400 is executed, for example, only in response to an appointment request (i.e., “on the fly”).

FIG. 5 is a flow diagram illustrating an example process 500 generally representative of multiple program instructions of the pricing module 206, coupled to the scheduling module 208, for execution by the processor(s) 202 of the pricing server 200 in FIG. 2. The process 500 may be executed, for example, during step 406 of the process 400 (FIG. 4).

In embodiments, the price for each appointment slot (i.e., each slot of the plurality of appointment slots available from a provider offering service of a healthcare resource) may be dynamically computed using a dynamic pricing algorithm. In one approach, the dynamic pricing algorithm places certain constraints on the price by employing several weighted functions. The weighted functions operate as various factors, taking into consideration the certain constraints, that affect the price (e.g., higher or lower). The certain constraints are derived from the resource data, which includes historical data, real-time data, and provider data, where the constraints reflect different aspects of the flow in supply and demand associated with the resource. The price computed using the weighted functions (and accompanying constraints) may be represented by the following mathematical expression:

price=a₁*ƒ(x)+a₂*p(t)+a₃*g(nₓm)+a₄*h(x,y,z)+a₅*q(x)

As illustrated in FIG. 5, the process 500 starts at step 502. Step 502 includes calculating a forecast or predicted attractiveness value associated with a time slot (hereinafter, “time attractiveness factor”). The time attractiveness factor affects the price being computed by placing a constraint, or weight, on certain time slots that are attractive for scheduling a healthcare resource. For example, a time slot between midnight and 8 AM (of any day) is likely highly attractive for scheduling an appointment as the resource predictably will not be utilized during that time. As such, determining a value for the time attractiveness factor helps place a weight that could lower (or increase) the price for a particular time slot. The time attractiveness factor may be represented by the following function:

$$f ( x ) = \frac{1}{σ \sqrt{2 π}} {e}^{- \frac{{( x - μ )}^{2}}{2 {σ}^{2}}}$$

where x, σ, μ are additional factors that may be modified based on additional collected data associated with the resource.

At step 504, the pricing module proceeds by calculating an advanced booking value associated with how far in advance an appointment is being scheduled, or booked (hereinafter, “time advancement factor”). The time advancement factor affects the price being computed by placing a constraint, or weight, on certain appointment requests for services at a distant future. For example, an appointment request today for immediate service of a healthcare resource in one hour gets an unfavorable price as a higher cost is needed to compensate for the immediacy. In the example, the price computed for an appointment slot in one hour is higher than the price for an appointment slot the next day. The time advancement factor may be represented by the following function:

$$P ( t ) = \frac{a}{b + {e}^{- ct}}$$

where t is the time duration between the request time and the appointment time, and where a, b, and c are additional factors that may be modified based on additional collected data associated with the resource.

At step 506, the pricing module proceeds by calculating a reward/penalty value associated with a time gap that results when scheduling an appointment (hereinafter, “time gap factor”). The time gap factor affects the price being computed by placing a constraint, or weight, on certain appointment requests that create a time gap or “hole” in a series of appointment slots available from the provider. A term “hole” as used herein is an unscheduled appointment slot between two appointment slots. The time gap factor “rewards” an appointment scheduling that removes a hole (i.e., time gap) within the appointment series. On the other hand, the time gap factor “penalizes” an appointment scheduling that creates a hole within the appointment series. Utilization of a resource is more optimal by taking the “holes” into consideration as time gaps break continuity of service. For example, asking a technician to stay for two hours instead of coming back for one hour at two different times during the day results in inefficiency. As such, the time gap factor helps optimize computation of the price.

In the example shown below, the price is the same for every appointment slot available because the current appointment availability has no booking. Making an appointment, in this example, merely starts the scheduling process and does not disrupt any continuity (as no service exists). As such, choosing an appointment slot to schedule a new appointment will create no hole. It is also noted that scheduling an appointment at the edges (e.g., either 8:00 AM or 1:00 PM in the example) is not considered “creating a hole.” For either of the edge appointment slots, the employees, technician, and/or any other expenditures tied to the healthcare resource can be told to come in early or late to carry out the service, without expending additional costs. As such, scheduling during these time slots is not penalized.

| 8:00 AM | 9:00 AM | 10:00 AM | 11:00 AM | 12:00 PM | 1:00 PM |
|---|---|---|---|---|---|
| Same | Same | Same | Same Price | Same | Same |
| Price | Price | Price | | Price | Price |

The price does change, however, if the current appointment availability has one currently booked appointment slot, where scheduling a new appointment may create a hole. For example, as shown below, the 10:00 AM slot has been scheduled (previously) in the current series of available appointments. Scheduling an appointment at the 9:00 AM or the 11:00 AM slot will not create any additional holes. As such, scheduling at the 9:00 AM or the 11:00 AM results in a reward (reflected as a lower price). On the other hand, scheduling an appointment during the 12:00 PM slot will create a hole at 11:00 AM, and doing so results in a penalty (as reflected in a higher price). Further, if two holes are created as a result of an appointment, more penalty is given than if only one hole is created. For example, scheduling during the 1:00 PM slot creates two holes at 11:00 AM and 12:00 PM.

| 8:00 | | | | | |
|---|---|---|---|---|---|
| AM | 9:00 AM | [symbol] | 11:00 AM | 12:00 PM | 1:00 PM |
| Penalty | Reward | Scheduled | Reward | Penalty | More Penalty |

A scheduling that “closes the hole” is rewarded extra and is reflected in the price. For example, as shown below, scheduling an appointment at the 11:00 AM in a current appointment availability that already has two slots scheduled helps close the hole in the series of appointments. In such scenario, expenditures associated with the resource are saved by having the continuity of service (e.g., technician can stay from 10:00 AM to 12:00 PM). As such, the price is set much lower to reflect the extra reward for closing the hole. Scheduling an appointment at 8:00 AM will also create a hole in relation to the 10:00 AM slot, and a penalty is applied to the price at that time slot.

| 8:00 | | | | | |
|---|---|---|---|---|---|
| AM | 9:00 AM | [symbol] | 11:00 AM | [symbol] | 1:00 PM |
| Penalty | Reward | Scheduled | Extra Reward | Scheduled | Reward |

At step 508, the pricing module proceeds by calculating a disparate value associated with feedback input from the provider for affecting the prices computed (hereinafter, “disparate factor”). The feedback input is an input value specifying a constraint set on the price being computed, where the feedback value depends on various unfavorable (and favorable) scenarios faced by the provider. The scenarios are caused by disparate reasons unpredictable to the provider. The disparate factor allows the provider to affect the price in order to appropriately address the scenarios. The disparate factor may be represented by the following function:

h(x,y,z)

In some instances, the scenario may be an unexpected underutilization of certain resources. For example, a hospital experiences a record low number of patients which results in an excess supply of hospital beds. In such scenario, the provider may want to offer a deep discount for all available hospital beds, and may do so by submitting a provider input (via the disparate factor function) to affect the price being computed. In other instances, the disparate scenario may be an unexpected natural disaster resulting in high demand for certain resources, where the provider may want to increase the prices for those resources.

At step 510, the pricing module proceeds by calculating a payment discount value associated with a payment type used for paying an appointment for service of the resource (hereinafter, “payment factor”). The payment factor provides a savings incentive for consumers (and business incentive for the provider) by reducing the price for certain payment types. The payment type may be a parameter set by the system. The provider, in turn, may provider a parameter value specifying preferences associated with certain payment types. For example, the provider may submit a parameter of 2% to indicate it wishes to give a 2% discount to any cash payment transaction. The system, working with this parameter value, applies a 2% discount when real-time data indicates that a consumer is paying with cash for an appointment being scheduled. The payment factor may be represented by the following function:

q(x)

At step 512, the pricing module computes a price for each appointment slot based on the factors discussed above. In embodiments, the values determined from the functions in steps 502-510 are added to generate a weighted sum that constitutes the price. The computation may be represented by the following mathematical expression:

price=a₁*ƒ(x)+a₂*p(t)+a₃*g(n,m)+a₄*h(x,y,z)+a₅*q(x)
where a1, a2, a3, a4, and a5 may be readjusted based on additional collected data associated with the resource to improve the pricing computation.

In some embodiments, the pricing module proceeds with an additional step 514. At step 514, the computed price (from step 512) is compared to a minimum price set by the provider. The minimum price may be a parameter set by the system. The provider submits as a parameter value a minimum price to indicate a lowest price at which it is willing to accept for an appointment. In the decision step 514, if the result is not higher than the provider's minimum price (i.e., “NO”), the minimum price is set as the price for the particular time slot, instead of the computed price. If the result is higher than the minimum price, then the computed price (from step 512) is set as the price for the particular time slot. At step 518, the process 500 ends.

In some embodiments, the computed price may be stored in memory, such as a local storage and/or a remote storage. As discussed above in process 400, the computed price may be generated for immediate display in response to an appointment request, or it may be stored. The stored price is periodically updated according to a criterion parameter (e.g., time-based, detection of change in resource data, etc.).

In some embodiments, the pricing server may also receive inputs or updates, in addition to the research data, to compute the above-described factors. The inputs or updates may come from a remote provider or a peer group of independent institutions that may not otherwise be in shared communication of this information with one another.

FIG. 6 is a block diagram illustrating an architecture of the pricing module 600 in accordance with one or more embodiments of the present invention. The pricing module 600 includes a dynamic pricing unit 610. The dynamic pricing unit 610 contains a dynamic pricing algorithm that takes into account the resource data to compute dynamically a price 630 corresponding to an appointment slot associated with a particular resource. For example, the price $500 is output by the dynamic pricing unit 610 for a one-hour slot between 8-9 pm on Sunday Mar. 3, 2013 to utilize an MRI machine offered by a provider X.

In embodiments, the resource data include a plurality of data received as inputs by the dynamic pricing unit 610. In the illustration shown, the plurality of data includes real-time data 602, historical data 604, provider data 606, and data output from disparate function 620 (hereinafter, “disparate output”).

The real-time data 602 are interactive feedback data received as input in the pricing server. The real-time data 602 include, but are not limited to: a supply value; a demand value; a continuity of service value; a time advancement value; a time of day value; and a method of payment value. The term “supply” as discussed herein is a current number of units available for a particular resource being priced. Availability of a particular resource (e.g., units) may be determined with respect to a geographical location. For example, a supply of MRI machines is the total number of units available in a requesting user's neighborhood. The term “demand” as discussed herein in the context of real-time data 502 is a current number of clients in need of (i.e., requesting) a resource. Similar to supply, demand may be determined with respect to a geographical location. The term “continuity of service” as discussed herein refers to a value measuring the flow of healthcare service being delivered. Continuity of service takes into consideration, for example, that keeping a technician for an hour longer at the end of the day is cheaper than calling one at night. In another example, continuity of service takes into consideration that scheduling for a time gap in the middle of the day is cheaper than scheduling a technician on a busy night. The term “time advancement” as discussed herein refers to how much time in advance an appointment for utilization of a resource is scheduled. For example, a desired appointment slot that is scheduled two weeks in advance results in a price much lower than a slot being requested for the next hour. The term “time of day” as discussed herein refers the time being requested for the resource. For example, if the time of day desired is during the late night, instead of a prime mid-day period, the price for the late night appointment slot is reduced. The term “method of payment” as discussed herein refers to a client's method of payment for utilizing the resource during a particular appointment slot. If the method of payment is cash, for example, the price is reduced for the particular appointment being scheduled by the user.

The historical data 604 are historical data acquired and stored in memory (e.g., local database and/or remote database). The historical data 604 include, but are not limited to: a demand value; and a location value. The term “demand” as discussed herein in the context of historical data refers to a past number of clients that have historically requested a particular resource. Similar to real-time demand, demand in the historical context may be determined with respect to a geographical location associated with utilization of a particular resource. The term “location” as discussed herein in the context of historical data refers to a geographical location associated with a historical utilization of a particular resource. In some instances, the geographical location is determined from the perspective of the provider. For example, the geographical area of the provider offering the resource in the past (e.g., a Palo Alto provider had available an MRI machine for four months during Sundays). In other instances, the geographical location is determined from the perspective of the client requesting the resource. For example, the geographical area is a request area in which the request originates (e.g., five requests were received from a medical clinic in Palo Alto last month).

In some embodiments, the historical data are stored in a local database of the local storage 220 and/or a remote database of the storage subsystem 232 of FIG. 2. In some instances, the historical data are acquired asynchronously as the data become available. In other instances, the historical data are acquired at designated time intervals (e.g. every 30 minutes, every hour, every week, etc.).

The provider data may be real-time data and/or historical data. The provider data include input values and parameter values received from a provider. The term “input values” as defined herein are input data submitted by a provider to specify certain constraints on the price being dynamically computed by the pricing server. For example, the input values are the feedback input provided by the provider for addressing (in relation to the price) certain scenarios caused by disparate reasons unpredictable to the provider. As discussed above, through these feedback input, the provider is able to affect the price being computed for each of the available appointment slots. It is noted, while the disparate function 620 is illustrated in FIG. 6 as being separate from the dynamic pricing unit, such separation is merely for highlighting the disparate factor. The highlighting emphasizes that the pricing server takes into consideration unpredictable scenarios faced by the provider, and allows the provider to affect the dynamic pricing process. Such highlighting does not deviate from the above-discussed process of FIG. 5. The term “parameter values” as defined herein are configuration values for system parameters set by the pricing server. A system parameter may be, for example, a payment type parameter set by the pricing server to enable a provider to apply discounts associated with a resource. The provider may submit to the pricing server, for example, a 10% discount to be applied to all utilization requests for an MRI machine during the next 10 days. The pricing server takes that parameter value, 0.10, into consideration when it dynamically computes the pricing options associated with that provider for an MRI machine request.

FIG. 7 is an example illustrating a user interface 700 on which a client may connect to the pricing server in accordance with one or more embodiments of the present invention. In the illustration, a client (e.g., laptop, PC, mobile device) accesses the user interface 700 to start searching for a specific MRI resource to carry out an MRI screening procedure. In an illustrative example, a user uses a laptop (i.e., the client) to access the user interface 700 by launching a web browser that navigates to a webpage 702 of the user interface 700.

The webpage 702 of FIG. 7 is called “RESOURCEDemand.” Featured on the webpage 702 are advertisements 730 from various resource providers. In some embodiments, the advertisements may change contextually based on different factors (e.g., the type of MRI machine being requested, the location at which a resource is being requested, etc.). The webpage 702 allows the client to submit a search query to request for an appointment associated with a particular MRI machine. In the illustration, the search query may include a type of MRI 704, an appointment date 706, and a desired time period 708. Once submit button 710 is entered, the user interface 700 returns on the webpage 702 one or more appointments 720 associated with the resource requested. The appointments 720 include a list of available appointment slots, a list of providers, a list of insurance prices and corresponding co-pay amounts, and a list of actual prices (without insurance). As discussed above, the insurance prices and the corresponding co-pay payments may be based on standardized insurance rates or personalized insurance rates of the user submitting the search query.

The client may enter a new search query and resubmit the utilization request to receive new appointments 720. In some embodiments, by clicking on any of the appointments, the client may proceed to a verification webpage to submit finalized details about payment for the selected appointment.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or sub-combinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts included in such references to provide further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

While certain aspects of the invention are presented below in certain claim forms, the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for.”) Accordingly, the applicant reserves the right to add additional claims after filing the application to pursue such additional claim forms for other aspects of the invention.

What is claimed is:

1. A method comprising:
acquiring resource data associated with a healthcare resource;
determining dynamic pricing constraints on a plurality of appointment slots available from a resource provider, the dynamic pricing constraints derived from the resource data; and
generating a price for each appointment slot based on the dynamic pricing constraints.

2. The method of claim 1, wherein acquiring resource data comprises:
acquiring provider data;
acquiring historical data; and
acquiring real-time data.

3. The method of claim 2, wherein the provider data comprises at least one of:
a provider parameter value,
wherein the provider parameter value is received from the provider for specifying certain constraints on the plurality of appointment slots.

4. The method of claim 2, wherein the provider data comprises:
a provider input value,
wherein the provider input value is received from the provider for specifying certain constraints on the plurality of appointment slots.

5. The method of claim 2, wherein the historical data comprises at least one of:
a demand value; and
a location value.

6. The method of claim 2, wherein the real-time data comprises at least one of:
a supply value;
a demand value;
a continuity of service value;
a time advancement value;
a time of day value; and
a method of payment value.

7. The method of claim 1, wherein determining dynamic pricing constraints comprises:
computing a time attractiveness value;
computing a time advancement value;
computing a time gap value;
computing a disparate value; and
computing a payment value.

8. The method of claim 1, wherein generating a price for each appointment slot based on the dynamic pricing constraints comprises:
computing the price for each appointment slot based on a time attractiveness value, a time advancement value, a time gap value, a disparate value, and a payment value.

9. The method of claim 8, further comprising:
comparing the price to a minimum price set by the resource provider, wherein the minimum price specifies a value at which the resource provider is willing to accept for offering service of the healthcare resource, and wherein the minimum price is a provider parameter value; and
returning the minimum price as the price for the appointment slot upon a determination that the price computed is lower than the minimum price.

10. The method of claim 1, further comprising:
storing the price for each appointment slot in a database.

11. The method of claim 10, further comprising:
updating the price for each appointment slot upon detection of new resource data being acquired.

12. The method of claim 10, further comprising:
updating the price for each appointment slot periodically based on a set time interval.

13. A method comprising:
receiving from a client an appointment request for a healthcare resource; and
generating in response to the appointment request a plurality of time slots and a plurality of prices corresponding to the time slots,
wherein the plurality of prices is dynamically computed based on resource data associated with the healthcare resource.

14. The method of claim 13, wherein generating in response to the appointment request a plurality of time slots and a plurality of prices comprises:
acquiring the resource data associated with the healthcare resource;
determining the plurality of time slots available for utilization of the healthcare resource based on the resource data; and
computing the plurality of prices based on the resource data.

15. The method of claim 14, wherein the resource data comprises:
provider data;
historical data; and
real-time data.

16. The method of claim 15, wherein the provider data comprises at least one of:
a parameter value; and
a provider input value.

17. The method of claim 15, wherein the historical data comprises at least one of:
a demand value; and
a location value.

18. The method of claim 15, wherein the real-time data comprises at least one of:
a supply value;
a demand value;
a continuity of service value;
a time advancement value;
a time of day value; and
a method of payment value.

19. The method of claim 15, wherein the real-time data comprises search criteria associated with the appointment request for the healthcare resource.

20. The method of claim 13, wherein generating in response to the appointment request a plurality of time slots and a plurality of prices comprises:
acquiring the resource data associated with the healthcare resource;
identifying a provider having the healthcare resource available for utilization based on the resource data;
identifying the plurality of time slots being offered by the provider for utilization of the healthcare resource based on the resource data;
computing for each time slot a price using dynamic pricing constraints based on the resource data; and
producing a plurality of appointments containing the plurality of time slots and the plurality of prices.

21. The method of claim 20, wherein the dynamic pricing constraints comprise at least one of:
a time attractiveness constraint;
a time advancement constraint;
a time gap constraint;
a disparate constraint;
a payment constraint; and
a minimum price constraint.

22. The method claim 13, further comprising:
displaying to the client the plurality of time slots and the plurality of prices;
receiving from the client a selection of a given time slot accompanied by a given price;
scheduling utilization of the healthcare resource in the given time slot.

23. The method of claim 22, further comprising:
updating a supply value associated with the healthcare resource in response to the scheduling.

24. The method of claim 22, further comprising transmitting, in response to the scheduling, a scheduling notification to a given provider associated with the given time slot.

25. The method of claim 13, wherein generating in response to the appointment request a plurality of time slots and a plurality of prices comprises:
transmitting a query request to a database for identifying a plurality of appointments corresponding to the query request, the query request generated based on the appointment request, the plurality of appointments including the plurality of time slots and the plurality of prices; and
displaying for the client the plurality of appointments.

26. A system comprising:
means for acquiring resource data associated with a healthcare resource;
means for analyzing the acquired data to identify a plurality of appointments available from a provider of the healthcare resource,
wherein each of the plurality of appointments includes a time slot and a price dynamically computed for the time slot using dynamic pricing constraints based on the resource data.

27. The system of claim 26, wherein means for acquiring resource data comprises:
means for acquiring provider data;
means for acquiring historical data; and
means for acquiring real-time data.

28. The system of claim 26, further comprising means for determining the dynamic pricing constraints, the dynamic pricing constraints including:
a time attractiveness value;
a time advancement value;
a time gap value;
a disparate value; and
a payment value.

29. The system of claim 26, further comprising:
means for comparing the price to a minimum price set by the provider, wherein the minimum price specifies a value at which the provider is willing to accept for offering service of the healthcare resource, and wherein the minimum price is a provider parameter value; and
means for returning the minimum price as the price for the time slot upon a determination that the price computed is lower than the minimum price.

30. The system of claim 26, further comprising:
means for storing the price for each time slot in a database.

31. The system of claim 27, further comprising:
means for updating the price for each time slot in the database.
